(19) United States
(12) Patent Application Publication
(10) Pub. No.: US 2014/0013912 A1
(43) Pub. Date: Jan. 16, 2014

(54) Cutter

(71) Applicant: NINGBO DEFENG POWER TECHNOLOGY CO., LTD., Ningbo (CN)

(72) Inventors: Shige Chen, Ningbo (CN); Xiwan Song, Ningbo (CN); Yingping Shao, Ningbo (CN); Luhua Guo, Ningbo (CN)

(73) Assignee: NINGBO DEFENG POWER TECHNOLOGY CO., LTD., Ningbo (CN)

(21) Appl. No.: 13/804,933

(22) Filed: Mar. 14, 2013

(30) Foreign Application Priority Data
Jul. 11, 2012 (CN) 201210241385.1

(51) Int. Cl. B23D 45/02

(52) U.S. Cl. CPC B23D 45/021
USPC 83/471.3

(57) ABSTRACT

Disclosed is a cutter including a base; an operating rotary table which is rotatably supported on the base; a sliding block; a rocking bar; a motor; a main shaft or a driven shaft driven by the main shaft of the motor being parallel to an upper surface of the operating rotary table; and a disk saw blade which is mounted and fixed on the main shaft or the driven shaft of the motor with its center hole so that the disk saw blade is rotated along with rotation of the main shaft or the driven shaft.

### CROSS REFERENCE TO RELATED APPLICATIONS

This application claims the benefit of Chinese Patent Application No. 201210241385.1, filed Jul. 11, 2012, which is hereby incorporated by reference in its entirety.

### FIELD OF THE INVENTION

The present invention relates to a powered tool, particularly, a cutter in which a saw blade can be moved in a front-rear direction by causing a sliding block to slide along a slide way provided in an operating rotary table.

### BACKGROUND OF THE INVENTION

A cutter is also known as a cutting saw, and is classified into a vertical cutter and a tiltable cutter according to an angular relationship of a saw blade relative to an operating rotary table. In the vertical cutter, the saw blade performs cutting perpendicularly to the operating rotary table but can not be adjusted in its angle with respect to the operating rotary table. In the tiltable cutter, the saw blade provided on the body can be adjusted in its cutting angle with respect to the operating rotary table.

Furthermore, in order to increase an effective cutting distance of the cutter, in the case that the saw blade's diameter remains unchanged, the cutter is normally designed so that the saw blade can be moved reciprocatingly in its radial direction with respect to the operating rotary table. The reciprocating movement of the saw blade on the body with respect to the operating rotary table may be achieved in two manners, that is, a pull bar type and a slide bush type. The pull bar type means that the saw blade is connected to a pull bar via the body and the pull bar is moved reciprocatingly in a sliding block fixed with respect to the operating rotary table so that the saw blade can be moved forward or backward with respect to the operating rotary table. The slide bush type means that the saw blade is connected to a sliding block via the body and the sliding block is moved reciprocatingly on a slide way fixed with respect to the operating rotary table so that the saw blade can be moved forward or backward with respect to the operating rotary table.

With regard to the pull bar type cutter, the sliding block is fixed and the pull bar is in a cantilevered state with respect to the sliding block. When the pull bar protrudes far away from the sliding block, a positional deviation of the saw blade with respect to the operating rotary table is large. As a result, a cutter which has a strict requirement for processing errors tends more to select the slide bush type.

Utility model patent No. ZL200420019357.6 describes a slide bush type tiltable cutter. The tiltable cutter includes an operating table 1, a body 5 above the operating table 1, a saw blade 7 provided on the body 5, and a rocking bar 2 located on a rear side of the operating table, wherein two pull bars 3 parallel to each other are provided on an upper end surface of the rocking bar 2, both ends of each of the pull bars 3 are fixed to the upper end surface of the rocking bar 2, and two bushes 4 are joined integrally with the body 5 and are slidably nested on the pull bars 3 respectively. As for such tiltable cutter, a lower end of the rocking bar is in hinged connection with a connecting shaft protruding from a side portion of the operating table, and an upper end of the rocking bar is fixed to the both ends of each of the pull bars 3 which are longer. Consequently, the rocking bar is desired to be fabricated into a shape with a long upper end and a short lower end and be supported to a hinge shaft. The rocking bar has a relatively complicated structure, a large height and a heavy weight. As a whole, the body is supported to the connecting shaft protruding from the side portion of the operating table with the lower end of the rocking bar as one point, which will bring an adverse influence to smooth operation of the cutter.

### SUMMARY OF THE INVENTION

The technical problem to be solved by the present invention is to increase rigidity of a slide way and improve fitting state of a sliding block and the slide way so as to optimize the structure of the cutter by causing the slide way to be fixedly connected to an operating rotary table at least at its two ends.

In order to solve the above problem, according to one aspect of the present invention, there is provided a cutter comprising: a base; an operating rotary table which is rotatably supported on the base, on a proximal end of which is provided with a linear kerf provided in a proximal-distal direction, and on a distal end of which is provided with a slide way provided along or parallelly to an extension line of the kerf; a sliding block, one of an upper portion and a lower portion of which is in slip fit with the slide way; a rocking bar, a lower end of which is in hinged connection with the other of the upper portion and the lower portion of the sliding block and can be locked so that the rocking bar is adjusted in its angle and is locked with respect to the sliding block in the left-right direction; a body, a distal end of which is in hinged connection with the rocking bar and on a proximal end of which is provided with a handle so that the body is pivoted about a hinge shaft in the up-down direction and is moved along the slide way by a force applied via the handle; a motor having a casing which is fixedly connected to the body so that a main shaft or a driven shaft driven by the main shaft of the motor is parallel to an upper surface of the operating rotary table; and a disk saw blade which is mounted and fixed on the main shaft or the driven shaft of the motor with its center hole so that the disk saw blade is rotated along with rotation of the main shaft or the driven shaft, and a plane in which the disk saw blade is aligned with the kerf in the operating rotary table, wherein a maximum sliding distance of the sliding block with respect to the slide way corresponds to a length of the kerf, and the slide way are fixedly connected to the operating rotary table at least at its two ends.

In the cutter according to one aspect of the present invention, the body can be moved forward or backward with respect to the operating rotary table, the angle of the saw blade with respect to the operating rotary table can be adjusted, and the slide way are fixedly connected to the operating rotary table at least at its two ends. Therefore, rigidity of the slide way is increased, fitting state of the sliding block and the slide way is improved, the structure of the cutter is optimized, and processing accuracy of the cutter is improved.

In the cutter according to one aspect of the present invention, in the slip fit of the sliding block and the slide way, the slide way may include a groove which is provided in the operating rotary table parallel to the extension line of the kerf, two cylindrical sliding rods are provided along the extension line within the groove, the lower portion of the sliding block has a shape matching the cylindrical sliding rods and is in slip fit with them, and the upper portion of the sliding block is in hinged connection with the rocking bar.

In the cutter according to one aspect of the present invention, in the slip fit of the sliding block and the slide way, the slide way may include a groove which is provided in the operating rotary table parallel to the extension line of the kerf, two cylindrical sliding rods are provided along the extension line above an upper surface of the operating rotary table on both sides of the groove, the upper portion of the sliding block has a shape matching the cylindrical sliding rods and is in slip fit with them, and the lower portion of the sliding block is contained within the groove and is in hinged connection with the rocking bar.

In the cutter according to one aspect of the present invention, in the slip fit of the sliding block and the slide way, the slide way may include a groove which is provided in the operating rotary table parallel to the extension line of the kerf, one cylindrical sliding rod is provided along the extension line on one side of the groove, a laterally recessed slide groove is provided in a side wall on the other side of the groove, the lower portion of the sliding block has a shape matching the sliding rod and the slide groove and is in slip fit with them, and the upper portion of the sliding block is in hinged connection with the rocking bar. The slide groove may have a C-shaped section or a “[”-shaped section.

In the cutter according to one aspect of the present invention, in the slip fit of the sliding block and the slide way, the slide way may include a groove which is provided in the operating rotary table parallel to the extension line of the kerf, laterally recessed slide grooves are provided in side walls on both sides of the groove, the lower portion of the sliding block has a shape matching the slide grooves and is in slip fit with them, and the upper portion of the sliding block is in hinged connection with the rocking bar. The slide grooves may have C-shaped sections or [-shaped sections.

In the cutter according to one aspect of the present invention, in the slip fit of the sliding block and the slide way, the slide way may include a groove which is provided in the operating rotary table parallel to the extension line of the kerf, a frame with a Π-shaped section protrudes upward from a bottom of the groove, slide plates with semicircular or rectangular sections are symmetrically provided on both sides of an upper end of the frame, and the sliding block has a corresponding portion with a shape matching the slide plates and is in slip fit with them.

In the cutter according to one aspect of the present invention, a center of a hinge shaft through which the sliding block and the rocking bar are connected may be located on or above or below the upper surface of the operating rotary table at a distance equal to or smaller than 5 mm from the upper surface. Preferably, the center of the hinge shaft is located on the upper surface of the operating rotary table.

In the cutter according to one aspect of the present invention, the following relational expression may be satisfied: A<C+E, wherein A denotes a maximum width of a workpiece to be processed, C denotes a maximum sliding distance of the sliding block with respect to the slide way, and E denotes a cutting distance of the disk saw blade itself. The following relational expression may be satisfied: L>A, wherein L denotes a minimum length of the kerf. The following relational expression may be satisfied: E=2\sqrt{D(H−D)}, wherein H denotes a diameter of the saw blade, and D denotes a depth by which the saw blade protrudes downward with respect to the upper surface of the operating rotary table.

In the cutter according to one aspect of the present invention, a width of the kerf may be equal to or smaller than 15 mm.

In the cutter according to one aspect of the present invention, when a vertical axis is set at 0°, an angle in which the body is pivoted about a hinge shaft through which the sliding block and the rocking bar are connected may be within a range of ±48°, and the body can be locked at any point within that range. Preferably, the angle may be within a range of ±45°, and the body can be locked at any point within that range.

According to another aspect of the present invention, there is provided a cutter comprising: a base; an operating rotary table which is rotatably supported on the base, on a proximal end of which is provided with a linear kerf provided in a proximal-distal direction, and on a distal end of which is provided with a slide way provided along or parallelly to an extension line of the kerf; a sliding block, a lower portion of which is in slip fit with the slide way; a body, a distal end of which is in hinged connection with the sliding block and on a proximal end of which is provided with a handle so that the body is pivoted about a hinge shaft and is moved along the slide way by a force applied via the handle; a motor having a casing which is fixedly connected to the body so that a main shaft or a driven shaft driven by the main shaft of the motor is parallel to an upper surface of the operating rotary table; and a disk saw blade which is nested on the main shaft or the driven shaft of the motor with its center hole and is fixed with it so that the disk saw blade is rotated along with rotation of the main shaft or the driven shaft, and a plane in which the disk saw blade is aligned with the kerf in the operating rotary table, wherein a maximum sliding distance of the sliding block with respect to the slide way corresponds to a length of the kerf, and the slide way are fixedly connected to the operating rotary table at least at its two ends.

In the cutter according to one aspect of the present invention, the body can be moved forward or backward with respect to the operating rotary table, and the slide way are fixedly connected to the operating rotary table at least at its two ends. Therefore, rigidity of the slide way is increased, fitting state of the sliding block and the slide way is improved, the structure of the cutter is optimized, and processing accuracy of the cutter is improved.

### BRIEF DESCRIPTION OF THE DRAWINGS

FIG. 1 is a general structural schematic diagram showing a cutter according to a first embodiment of the present invention.

FIG. 2 is an exploded perspective diagram showing the cutter according to the first embodiment.

FIG. 3 is a schematic diagram showing a state in which the cutter according to the first embodiment is cutting a workpiece.

FIG. 4 is a schematic diagram showing position restriction while a body is moving downward of the cutter according to the first embodiment.

FIG. 5 is a schematic diagram showing position restriction while the body is moving upward of the cutter according to the first embodiment.

FIG. 6 is a schematic diagram showing a state in which the body is locked at a vertical position of the cutter according to the first embodiment.

FIG. 7 is a schematic diagram showing a state in which the body is locked at a inclined 45° position of the cutter according to the first embodiment.

FIGS. 8 and 9 are schematic diagrams showing positional relationships of each of main components of the cutter according to the first embodiment.

FIGS. 10A and 10B are schematic diagrams showing position restriction and locking while the body is moving forward or backward of the cutter according to the first embodiment.

FIGS. 11A and 11B are sectional and plan schematic diagrams showing a block-way structure of the cutter according to the first embodiment respectively.

FIGS. 12A and 12B are sectional and plan schematic diagrams showing a block-way structure of the cutter according to a second embodiment respectively.

FIGS. 13A and 13B are sectional and plan schematic diagrams showing a block-way structure of the cutter according to a third embodiment respectively.

FIGS. 14A and 14B are sectional and plan schematic diagrams showing a block-way structure of the cutter according to a fourth embodiment respectively.

FIGS. 15A and 15B are sectional and plan schematic diagrams showing a block-way structure of the cutter according to the fourth embodiment respectively.

FIGS. 16A and 16B are sectional and plan schematic diagrams showing a block-way structure of the cutter according to a fifth embodiment respectively.

FIGS. 17A and 17B are sectional and plan schematic diagrams showing a block-way structure of the cutter according to the fifth embodiment respectively.

FIG. 18 is a schematic diagram showing a cutter according to a sixth embodiment of the present invention.

FIGS. 19A and 19B are schematic diagrams of Modification 1 regarding the slide way and the sliding block.

FIGS. 20A and 20B are schematic diagrams of Modification 2 regarding the slide way and the sliding block.

FIGS. 21A and 21B, FIGS. 22A and 22B, and FIGS. 23A and 23B are schematic diagrams of Modification 3 regarding the slide way and the sliding block.

### DETAILED DESCRIPTION OF THE PREFERRED EMBODIMENTS

Embodiments of the present invention will be described below with reference to accompanying drawings.

### First Embodiment

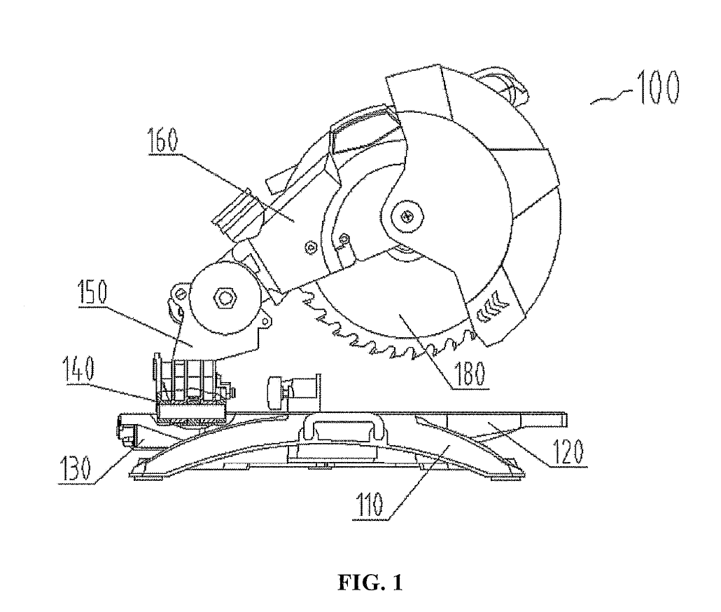

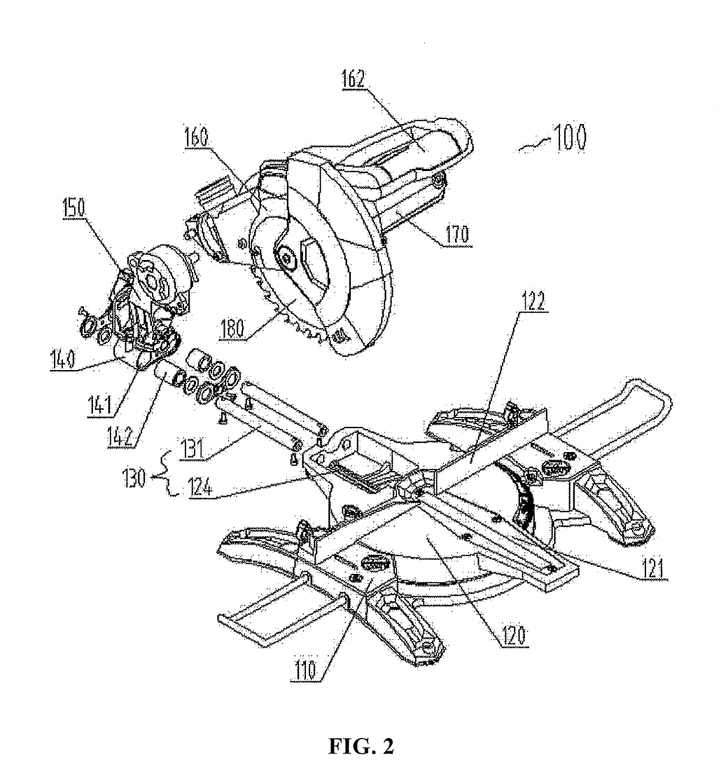

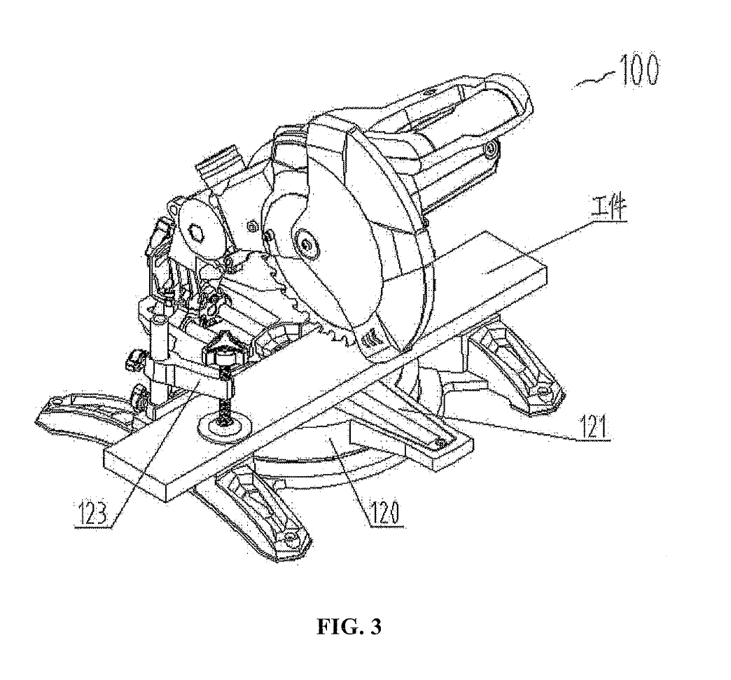

FIG. 1 is a general structural schematic diagram showing a cutter according to a first embodiment of the present invention. FIG. 2 is an exploded perspective diagram showing the cutter according to the first embodiment. FIG. 3 is a schematic diagram showing a state in which the cutter according to the first embodiment is cutting a workpiece. A general structure of the cutter according to the first embodiment will be described with reference to FIGS. 1 to 3.

As shown in FIGS. 1 to 3, a cutter 100 according to the first embodiment of the present invention includes a base 110, an operating rotary table 120, a slide way 130, a sliding block 140, a rocking bar 150, a body 160, a motor 170 and a disk saw blade 180.

The base 110 serves as a foundation of the cutter 100, is supported on a floor, and may have, for example, three or four legs. The total weight of the cutter 100 and that of a workpiece to be processed (shown in FIG. 3) are born by the base 110. Since the floor at a situation where the cutter 100 is used may be uneven, each or part of legs of the base 110 can be provided with a height regulation device (not shown), for example, a bolt-thread regulation device.

The operating rotary table 120 is a bench of the cutter 100, is detachably supported on the base 110, and can be rotated with respect to the base and be locked at any angle, thus processing expedience of the cutter 100 is improved.

To facilitate explanation, description will be made by taking an orientation in which a user views the cutter 100 at an operating position. For example, in a front-rear direction, a part near to the user is described as a proximal end, and a part distant from the user is described as a distal end. Likewise, a left hand side of the user is defined as a left side, and a right hand side of the user is defined as a right side. These specifications are similarly applicable to other aspects and other embodiments of the present invention.

On a proximal end of the operating rotary table 120 is provided with a linear kerf 121 which is provided in a proximal-distal direction, and on a distal end thereof is provided with the slide way 130 which is provided along or parallelly to a extension line of the kerf 121. The operating rotary table 120 further includes a workpiece barrier 122 which is provided on an upper surface thereof and a clamper 123 which fixes the workpiece to the upper surface. An end face of the workpiece barrier 122 can be perpendicular to the upper surface of the operating rotary table 120. Hence, when the workpiece is laid on the upper surface of the operating rotary table 120, the workpiece can be positioned rapidly by causing a side surface of the workpiece to abut against the end face of the workpiece barrier 122, and the workpiece can be fixed to the operating rotary table 120 rapidly through the clamper 123. For the case that a workpiece with a different shape is to be processed, the end face of the workpiece barrier 122 can also be designed into a bevel with a certain slope.

The slide way 130 can be provided above or below the upper surface of the operating rotary table 120, and the slide way 130 are fixedly connected to the operating rotary table 120 at least its two ends. In this embodiment, the slide way 130 is formed as two cylindrical sliding rods 131 which are provided below the upper surface of the operating rotary table 120. For this reason, a groove 124 which receives the two sliding rods 131 is provided at the position where the sliding rods 131 are provided in the operating rotary table 120, as shown in FIG. 2. The sliding rods 131 are designed to have enough rigidity, and each of the sliding rods 131 are fixedly connected to the operating rotary table 120 at least at its two ends. Thus, the sliding rods 131 are deformed less at the time of bearing a load. Alternatively, when the sliding rods 131 have a long length, in order to reduce deformation thereof, one to three supporting points may be added to each of the sliding rods 131, and these supporting points can be uniformly distributed on the sliding rods 131. For example, if three supporting points are increased, the three supporting points are provided at positions quartering the sliding rods 131.

The sliding block 140 has two sleeves 141 which are nested on the sliding rods 131 so that the sliding block 140 can be in slip fit with the sliding rods 131. In the embodiment, the two sleeves 141 are provided on a lower portion of the sliding block 140.

A linear bearing 142 may be provided between the sliding block 140 and the slide way 130 so as to decrease frictional resistance therebetween. For example, the linear bearing 142 is a ball linear bearing. The linear bearing 142 may be lubricated by a lubricating grease or a lubricating oil. When the lubricating oil is used, an oil hole leading to the linear bearing is provided on the sliding block 140.

In the embodiment, each of the sleeves 141 has a section shaped like a circular ring. Alternatively, when it is required that supporting points are added to each of the sliding rods 131 to increase rigidity of the sliding rods 131, the sleeves 141 can also have a section shaped like the larger half circle to avoid these supporting points so that the slip fit between the sleeves 141 and the sliding rods 131 is not affected.

In the embodiment, a hinge shaft hole 143 which is provided parallelly to the sleeves 141 is formed in an upper portion of the sliding block 140. For example, the hinge shaft hole 143 may be provided between the two sleeves 141, and a center of the hinge shaft hole 143 may be located at a distance within 5 mm from the upper surface of the operating rotary table 120, preferably, be registered with the upper surface.

The rocking bar 150 is a member which is pivotable leftward or rightward with respect to the sliding block 140. In the embodiment, a hinge shaft hole 151 which is in hinged connection with the hinge shaft hole 143 in the upper portion of the sliding block 140 and can lock the rocking bar 150 is provided in a lower end of the rocking bar 150 so that the angle of the rocking bar 150 in a left-right direction can be adjusted and be locked with respect to the sliding block 140. The angle adjustment and locking of the rocking bar 150 with respect to the sliding block 140 will be described in detail below.

A hinge shaft hole 152 which is provided in the left-right direction is formed in an upper end of the rocking bar 150.

The body 160 is a member fixed with the motor 170 and the saw blade 180, a hinge shaft hole 161 which is in hinged connection with the hinge shaft hole 152 of the rocking bar 150 is provided on a distal end of the body, and a handle 162 is provided on a proximal end of the body so that the body is pivoted about a hinge shaft between the body 160 and the rocking bar 150 and is moved along the slide way 130 by virtue of force applied via the handle 162.

In a central portion of the body 160, a casing of the motor 170 is fixedly connected to the body 160 so that a main shaft or a driven shaft driven by the main shaft of the motor 170 is parallel to the upper surface of the operating rotary table 120.

A center hole of the disk saw blade 180 is nested on the main shaft or the driven shaft of the motor 170 and is fixed with it so that the disk saw blade 180 is rotated along with rotation of the main shaft or the driven shaft, and a plane in which the disk saw blade 180 is aligned with the kerf 121 in the operating rotary table 120.

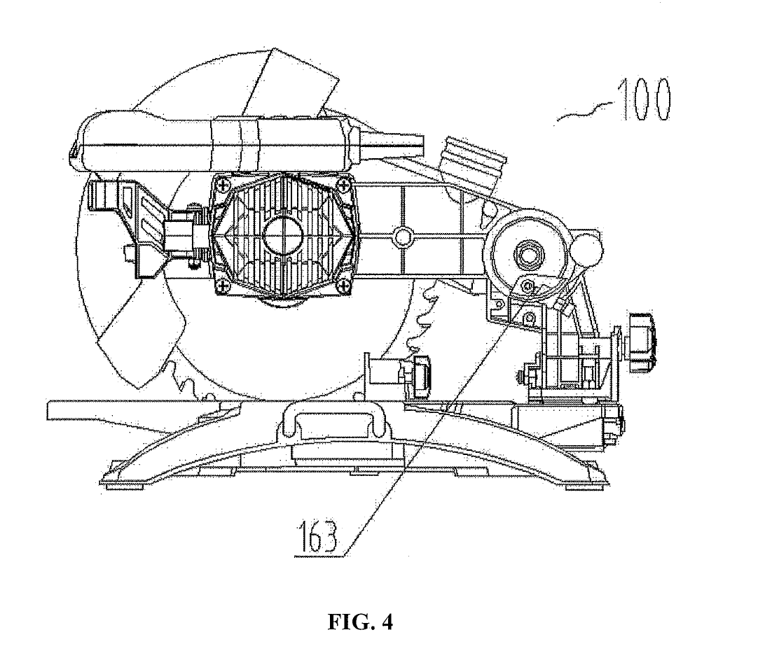

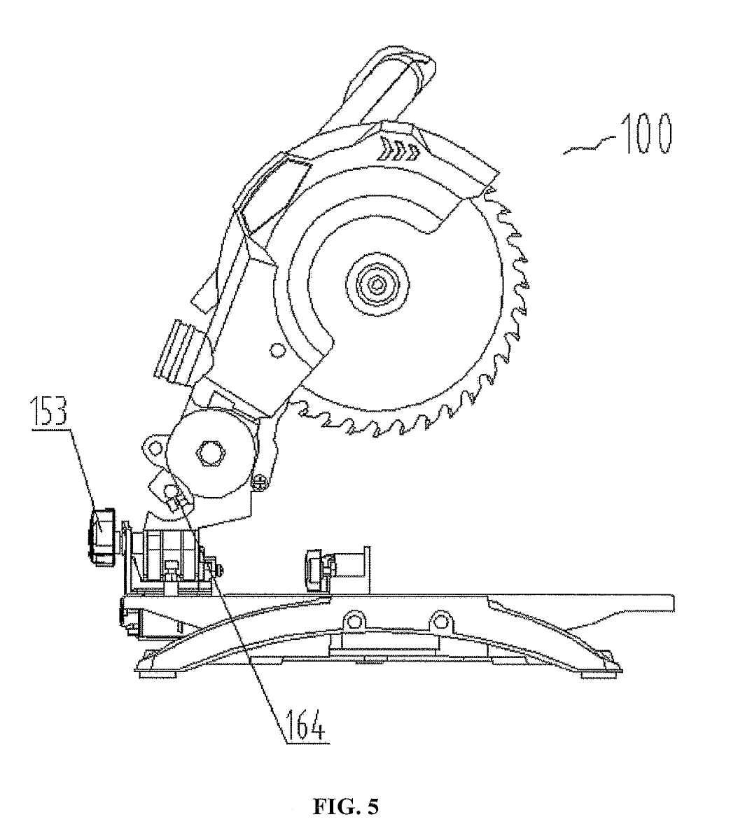

FIG. 4 is a schematic diagram showing position restriction while a body is moving downward of the cutter according to the first embodiment. FIG. 5 is a schematic diagram showing position restriction while the body is moving upward of the cutter according to the first embodiment.

In order to limit a displacement by which the body 160 is pivoted in a up-down direction to be within a specified range, a lower stopping device 163 (shown in FIG. 4) and an upper stopping device 164 (shown in FIG. 5) are provided on the rocking bar 150 and the body 160. As a result, a rotational angle of the body 160 about the hinge shaft between the body 160 and the rocking bar 150 is restricted, and thus a height range of the saw blade 180 relative to the operating rotary table 120 is restricted too. In order that the body 160 is in its upper limit position without application of force, a return spring may be provided on the hinge shaft between the body 160 and the rocking bar 150 so that the body 160 will automatically return to its upper limit position in case of no application of force.

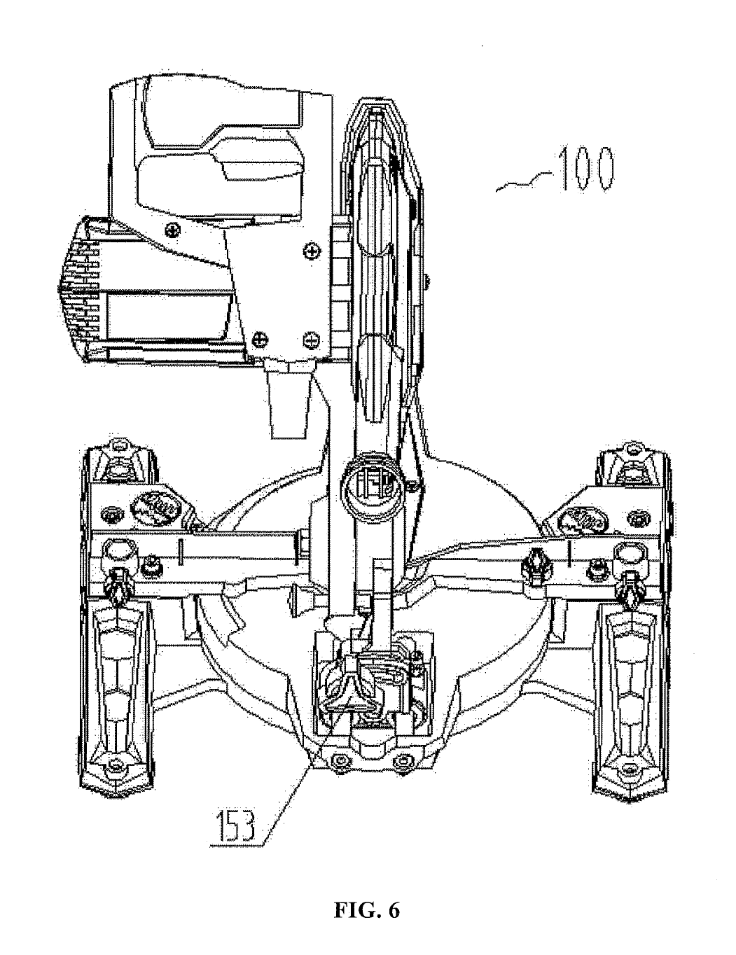

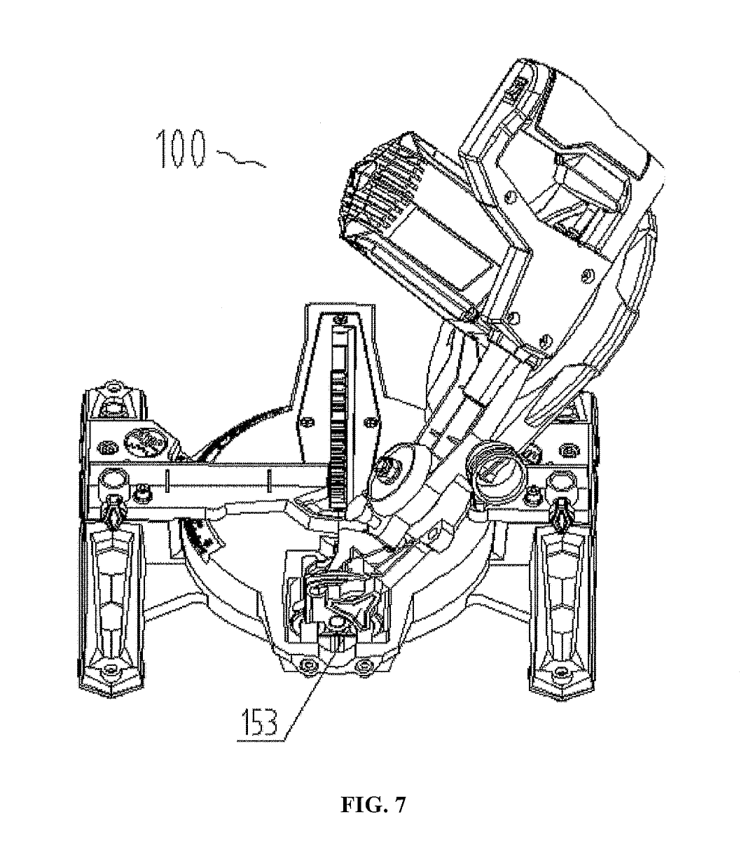

FIG. 6 is a schematic diagram showing a state in which the body is locked at a vertical position of the cutter according to the first embodiment. FIG. 7 is a schematic diagram showing a state in which the body is locked at a inclined 45° position of the cutter according to the first embodiment.

As shown in FIG. 6, when the saw blade 180 performs vertical cutting with respect to the operating rotary table 120, the rocking bar 150 is disposed vertically. That is, the rocking bar 150 protrudes upward from the sliding block 140 and does not have a rotational angle, and vertical cutting is performed with a plane in which the saw blade 180 exists being perpendicular to the upper surface of the operating rotary table 120.

As shown in FIG. 7, when the rocking bar 150 is pivoted by 45° rightward about a hinge shaft between the rocking bar 150 and the sliding block 140, the body 160 is also rotated by 45° rightward while carrying the motor 170 and the saw blade 180. The rocking bar 150 is locked by screwing up a rotary locking knob 153 connected to threads on the sliding block 140 so that the saw blade 180 can perform cutting while being inclined rightward at an angle of 45° with respect to the operating rotary table 120. Similarly, the saw blade 180 can perform cutting while being inclined leftward at an angle of 45° with respect to the operating rotary table 120. According to the present invention, the saw blade 180 can be inclined leftward or rightward at an angle of 48° with respect to the operating rotary table 120. Moreover, the saw blade 180 can be locked through the rotary locking knob 153 at any angle within a range of ±48° with respect to the operating rotary table 120. Thus, the saw blade 180 can perform cutting at any angle within the range of ±48° with respect to the workpiece. In this embodiment, cutting is preferably performed at any angle within a range of ±45° with respect to the workpiece.

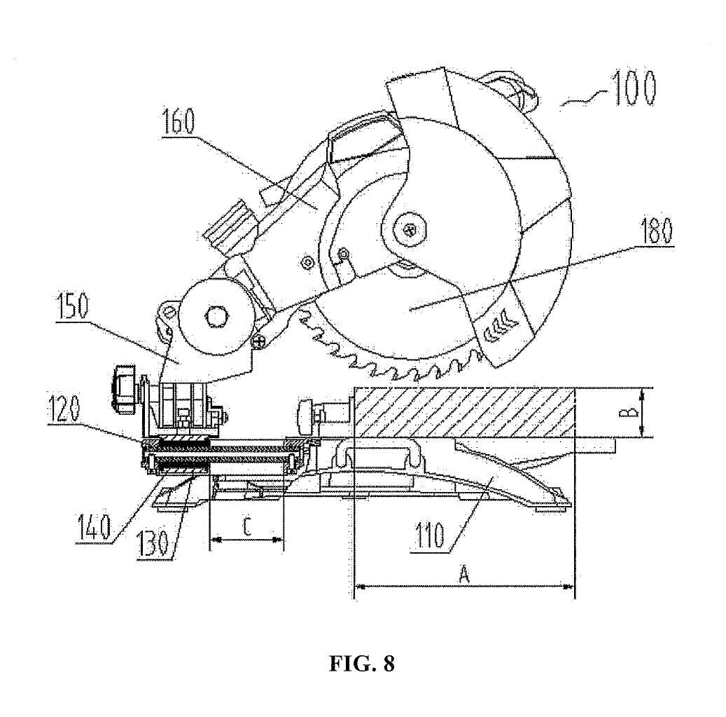

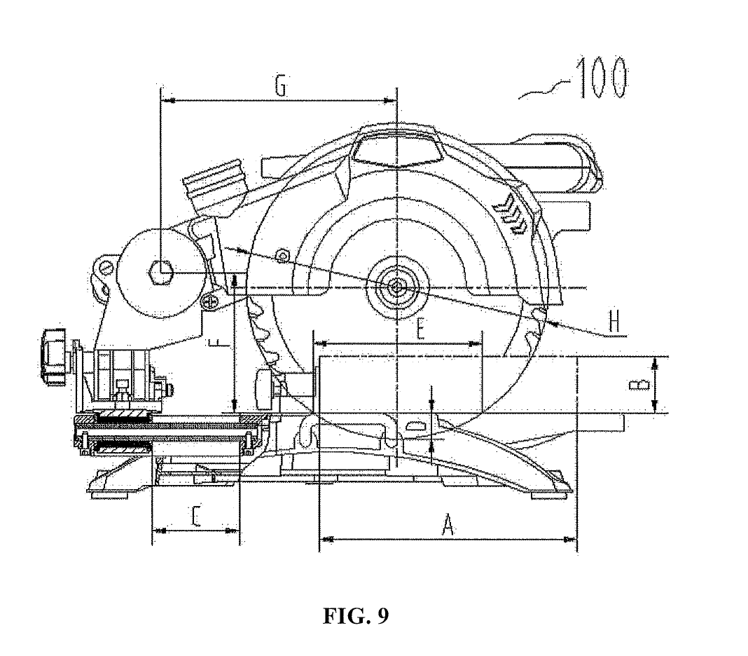

FIGS. 8 and 9 are schematic diagrams showing positional relationships of each of main components of the cutter according to the first embodiment.

As shown in FIGS. 7 to 9, if a center of the hinge shaft through which the sliding block 140 is in hinged connection with the rocking bar 150 is located on the upper surface of the operating rotary table 120, when the saw blade 180 is adjusted its angle relative to the upper surface, the position where the plane in which the saw blade 180 in present intersects the upper surface of operating rotary table 120 remains unchanged substantially so that the saw blade 180 always falls within the kerf 121 because its rotation shaft lies on the upper surface. When the center of the hinge shaft through which the sliding block 140 is in hinged connection with the rocking bar 150 is located above or below the upper surface of the operating rotary table 120, the position where the plane in which the saw blade 180 in present intersects the upper surface of operating rotary table 120 is changed accordingly, therefore the distance from the center of the hinge shaft through which the sliding block 140 is in hinged connection with the rocking bar 150 to the upper surface of the operating rotary table 120 is preferably equal to or smaller than 5 mm, more preferably 0. In designing of the cutter, the distance from the center of the hinge shaft through which the sliding block 140 is in hinged connection with the rocking bar 150 to the upper surface of the operating rotary table 120 can be flexibly controlled to be within the above range according to operating condition of the cutter.

Regarding a maximum sliding distance of the sliding block 140 with respect to the slide way 130, the following relational expression is satisfied: A<C+E, wherein A denotes a maximum width of the workpiece to be processed, C denotes a maximum sliding distance of the sliding block 140 with respect to the slide way 130, and E denotes a cutting distance of the disk saw blade 180 itself (a chord length on which the saw blade intersects the upper surface of the operating rotary table).

The following relational expression is satisfied: L>A, wherein L denotes a minimum length of the kerf 121.

The following relational expression is satisfied: E=2\sqrt{D(H−D)}, wherein H denotes a diameter of the saw blade 180, and D denotes a depth at which the saw blade 180 protrudes downward with respect to the upper surface of the operating rotary table 120.

According to the present embodiment, a width of the kerf 121 is equal to or smaller than 15 mm.

When a vertical axis is set at 0°, an angle in which the body 160 is pivoted about the hinge shaft through which the rocking bar 150 and the sliding block 140 are connected is within a range of ±48°, and the body 160 can be locked at any point within that range. Preferably, the angle in which the body 160 is pivoted about the hinge shaft through which the rocking bar 150 is connected to the sliding block 140 is within a range of ±45°, and the body 160 can be locked at any point within that range.

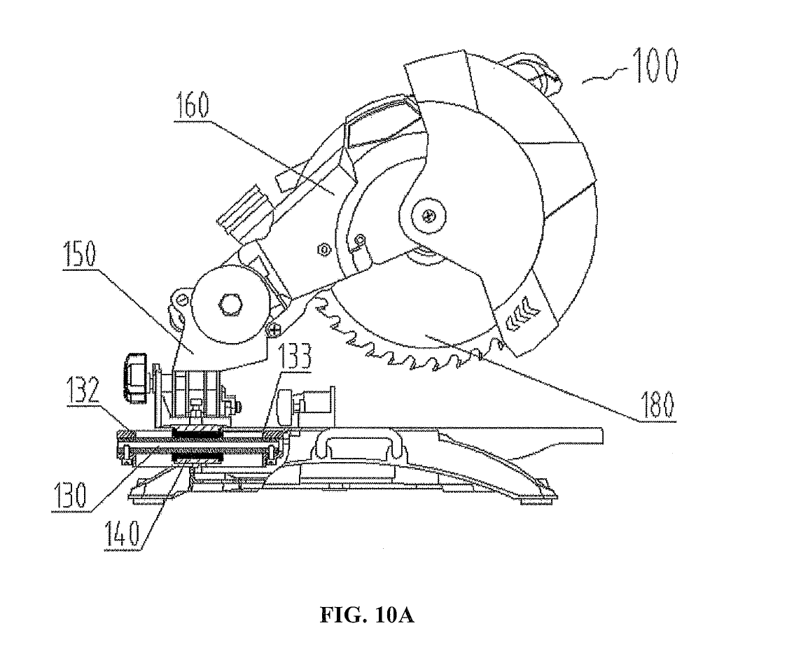

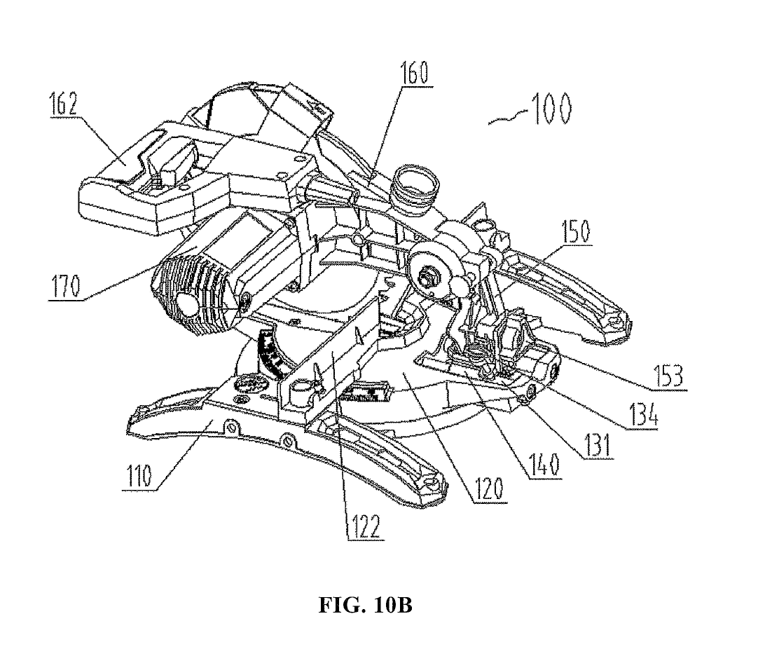

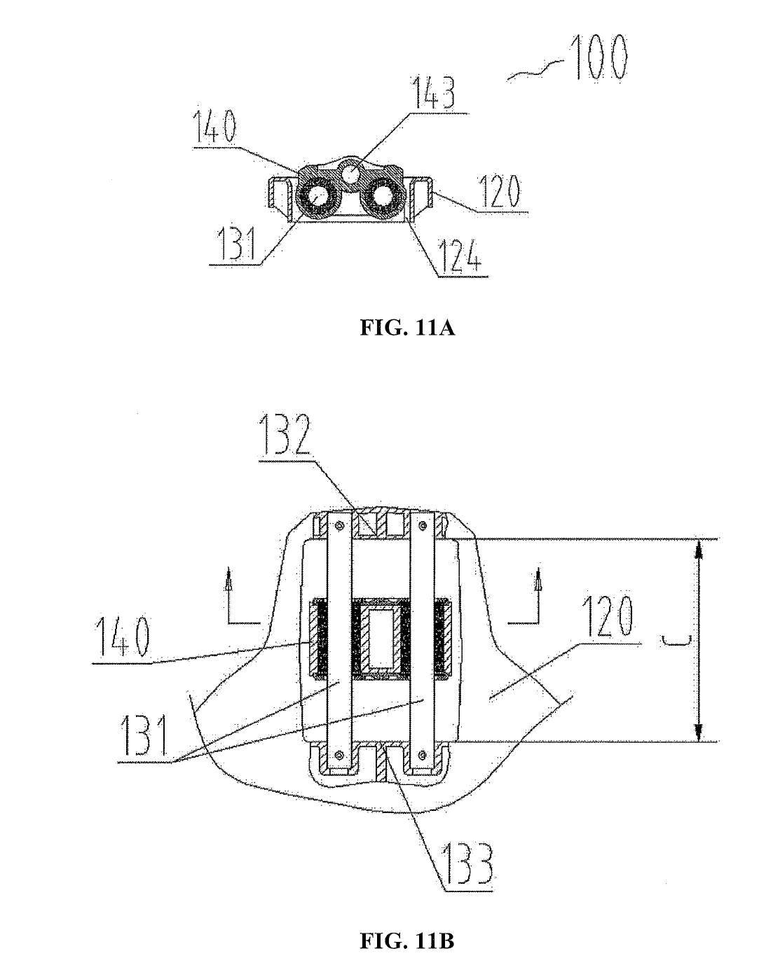

FIGS. 10A and 10B are schematic diagrams showing position restriction and locking while the body is moving forward or backward of the cutter according to the first embodiment. FIGS. 11A and 11B are sectional and plan schematic diagrams showing a block-way structure of the cutter according to the first embodiment respectively.

Next, arrangement of the sliding block and the slide way as well as mutual movement, position restriction and locking thereof of the cutter according to the first embodiment of the present invention will be described with reference to FIGS. 10A and 10B and FIGS. 11A and 11B.

In order that a center of the hinge shaft hole 143 through which the sliding block 140 is in hinged connection with the rocking bar 150 is substantially flush with the upper surface of the operating rotary table 120, the groove 124 is provided in the operating rotary table 120 and a size of the groove 124 corresponds to that needed for the slide way 130. As a consequence, in this embodiment, the slide way 130 including the two sliding rods 131 is provided below the upper surface of the operating rotary table 120 so that the center of the hinge shaft hole 143 for the sliding block 140 nested on the slide way 130 is flush with upper surface of the operating rotary table 120.

The sliding block 140 which carries the body 160 and the saw blade 180 on the body via the rocking bar 150 slides on a travel C defined by two end points 132 and 133 of the slide way 130, and the saw blade is moved with respect to the workpiece to be processed so that the workpiece is cut.

As shown in FIG. 10B, a positioning device 134 is provided on the sliding block 140 at a position corresponding to the sliding rods 131. For example, the positioning device 134 may be a screw connected to a threaded hole on the sliding block 140. During processing of the workpiece, when the sliding block 140 is required to be fixed at any point in the travel C and does not slide with respect to the slide way 130, the positioning device 134 may be locked, for example, by causing the screw to abut against the slide way 130 to tighten the screw. on the contrary, when the sliding block 140 is required to slide with respect to the slide way 130, the positioning device 134 is unlocked.

The cutter according to the first embodiment of the present invention can obtain the following beneficial effects.

(1) by providing the groove in the operating rotary table and placing the slide way in the groove, the center of the hinge shaft through which the rocking bar is in hinged connection with the sliding block is provided on the upper surface of the operating rotary table or is provided above or below the upper surface within a very narrow range easily.

(2) at least the two ends of the slide way are fixedly connected to the operating rotary table, therefore rigidity of the slide way is increased, thus processing accuracy of the cutter is improved.

(3) since the center of the hinge shaft through which the rocking bar is connected to the sliding block is quite low, the structure of the rocking bar is simplified and degree of freedom in designing the rocking bar is improved.

(4) since the structure for the body to rotate and move is optimized, the height of the body relative to the operating rotary table is decreased, operating stability of the cutter is improved, and the size and weight of the whole apparatus is reduced.

### Second Embodiment

In addition to the sliding block and the slide way, a cutter 200 according to a second embodiment of the present invention has the same structure as that of the cutter 100 according to the first embodiment of the present invention. Components having the same function are assigned the identical reference numerals except that one hundred is added thereto. Only differences between them will be described below to avoid redundancy.

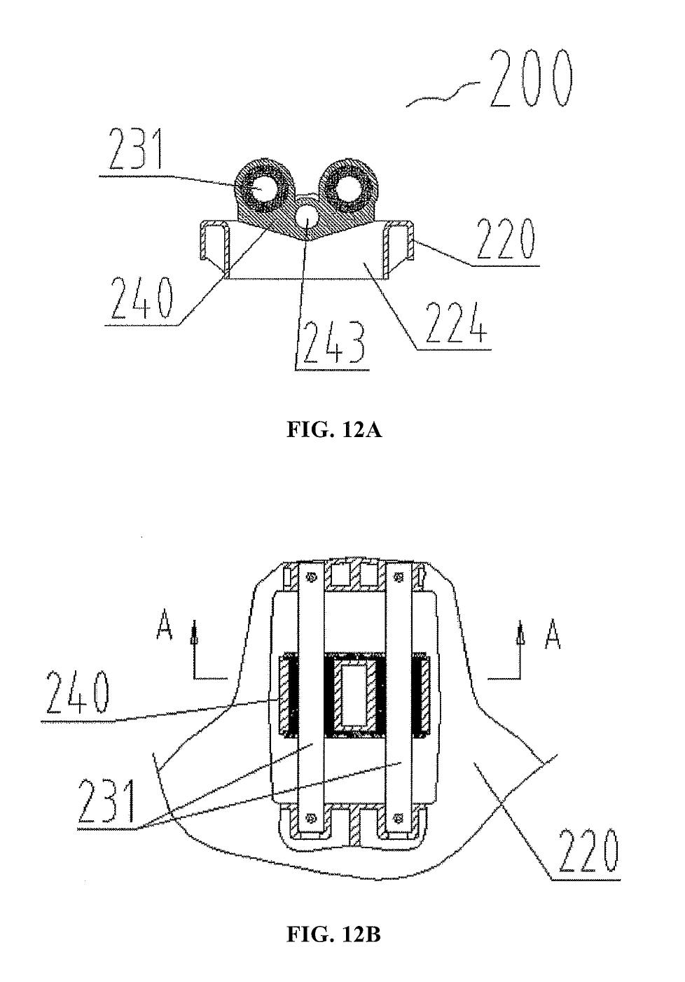

FIGS. 12A and 12B are sectional and plan schematic diagrams showing a block-way structure of the cutter according to the second embodiment respectively.

As shown in FIGS. 12A and 12B, in the slip fit of a sliding block 240 and a slide way 230 of the cutter 200, the slide way 230 includes a groove 224 which is provided in an operating rotary table 220 parallelly to an extension line of a kerf 221, and two cylindrical sliding rods 231 are provided along the extension line above an upper surface of the operating rotary table 220 on both sides of the groove 224. An upper portion of the sliding block 240 has a shape matching the sliding rods 231 and is in slip fit with them, and a lower portion of the sliding block 240 is contained within the groove 224 and is in hinged connection with the rocking bar (not shown) through a hinge shaft hole 243. Although not shown, two ends of each of the cylindrical sliding rods 231 may be fixedly connected to the operating rotary table 220 through a frame which is provided on the upper surface of the operating rotary table 220.

Because the two ends of the slide way 230 of the cutter 200 according to the second embodiment are fixedly connected to the operating rotary table 220 and the hinge shaft hole 243 through which the sliding block 240 is in hinged connection with the rocking bar is located on or near the upper surface of the operating rotary table 220, beneficial effects substantially the same as those of the cutter 100 according to the first embodiment can be obtained.

### Third Embodiment

In addition to the sliding block and the slide way, a cutter 300 according to a third embodiment of the present invention has the same structure as that of the cutter 100 according to the first embodiment of the present invention. Components having the same function are assigned the identical reference numerals except that two hundreds are added thereto. Only differences between them will be described below to avoid redundancy.

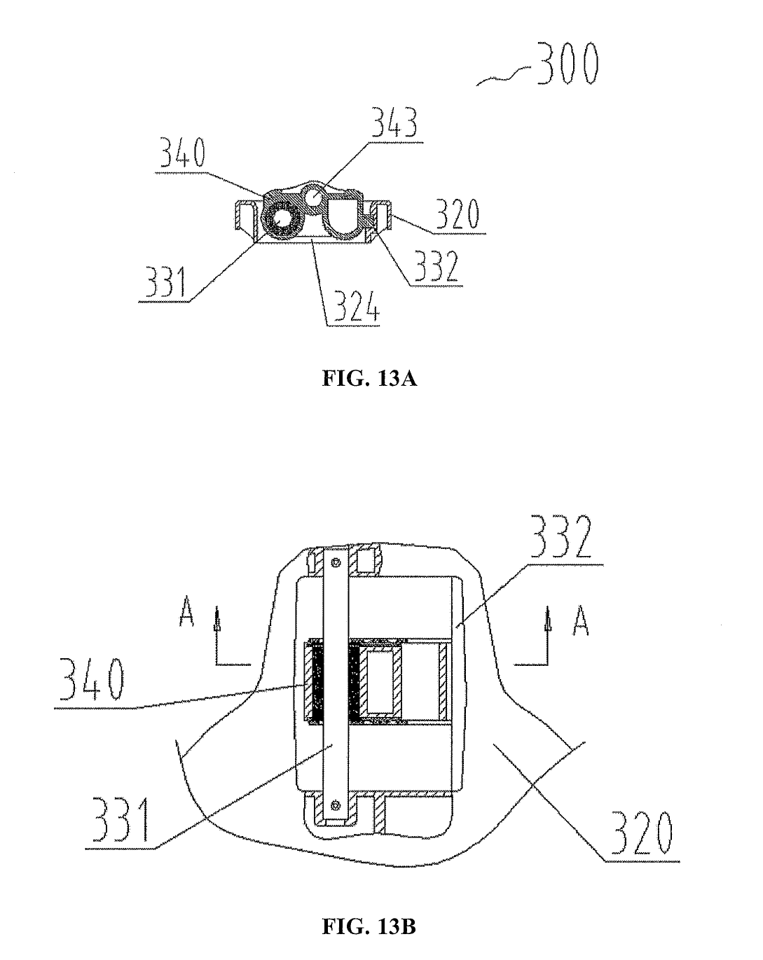

FIGS. 13A and 13B are sectional and plan schematic diagrams showing a block-way structure of the cutter according to the third embodiment respectively.

As shown in FIGS. 13A and 13B, in the slip fit of a sliding block 340 and a slide way 330 of the cutter 300, the slide way 330 includes a groove 324 which is provided in an operating rotary table 320 parallelly to an extension line of a kerf 321, one cylindrical sliding rod 331 is provided along the extension line on the left side of the groove 324, and a laterally recessed slide groove 332 is provided in a side wall on the right side of the groove 324. Positions where the sliding rod 331 and the slide groove 332 are provided are not limited thereto, and it is also possible that the one cylindrical sliding rod 331 is provided along the extension line on the right side of the groove 324, and the laterally recessed slide groove 332 is provided in a side wall on the left side of the groove 324. A lower portion of the sliding block 340 has a shape matching the sliding rod 331 and the slide groove 332 and is in slip fit with them, and an upper portion of the sliding block 340 is in hinged connection with the rocking bar (not shown). Although it is only shown in FIG. 13A that the slide groove 332 has a [-shaped section, the slide groove 332 can have a C-shaped section or a section with any other proper shape known to those skilled in the art.

Because the slide way 330 of the cutter 300 according to the third embodiment includes the sliding rod 331 two ends of which are fixedly connected to the operating rotary table 320 and the slide groove 332 which is embedded in the operating rotary table 320 or is formed integrally with the operating rotary table, and a hinge shaft hole 343 through which the sliding block 340 is in hinged connection with the rocking bar is located on or near the upper surface of the operating rotary table 320, beneficial effects substantially the same as those of the cutter 100 according to the first embodiment can be obtained.

### Fourth Embodiment

In addition to the sliding block and the slide way, a cutter 400 according to a fourth embodiment of the present invention has the same structure as that of the cutter 100 according to the first embodiment of the present invention. Components having the same function are assigned the identical reference numerals except that three hundreds are added thereto. Only differences between them will be described below to avoid redundancy.

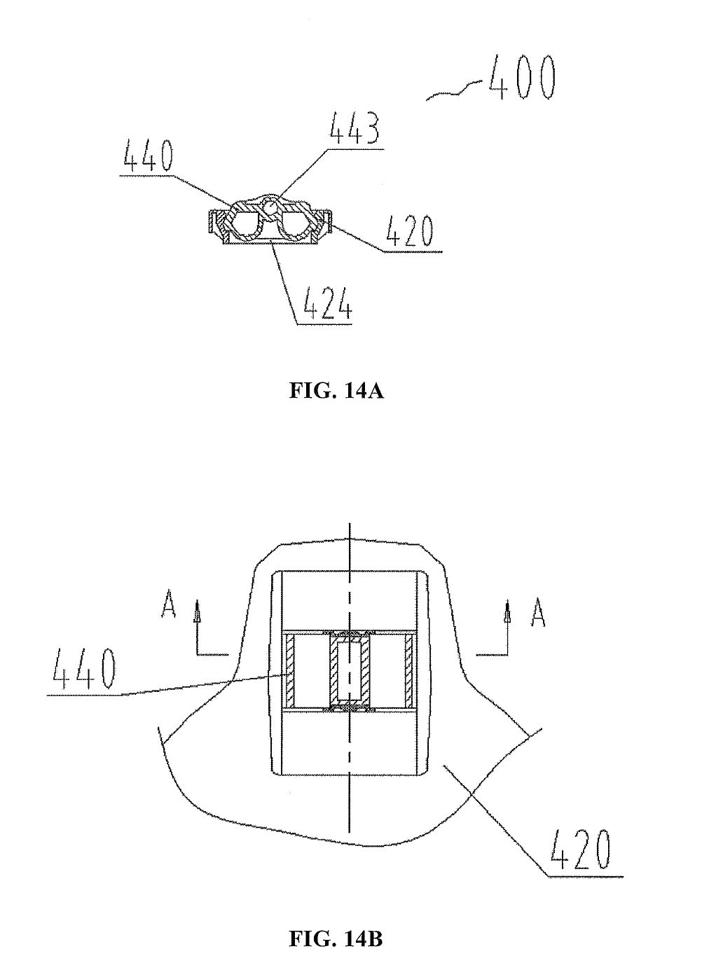

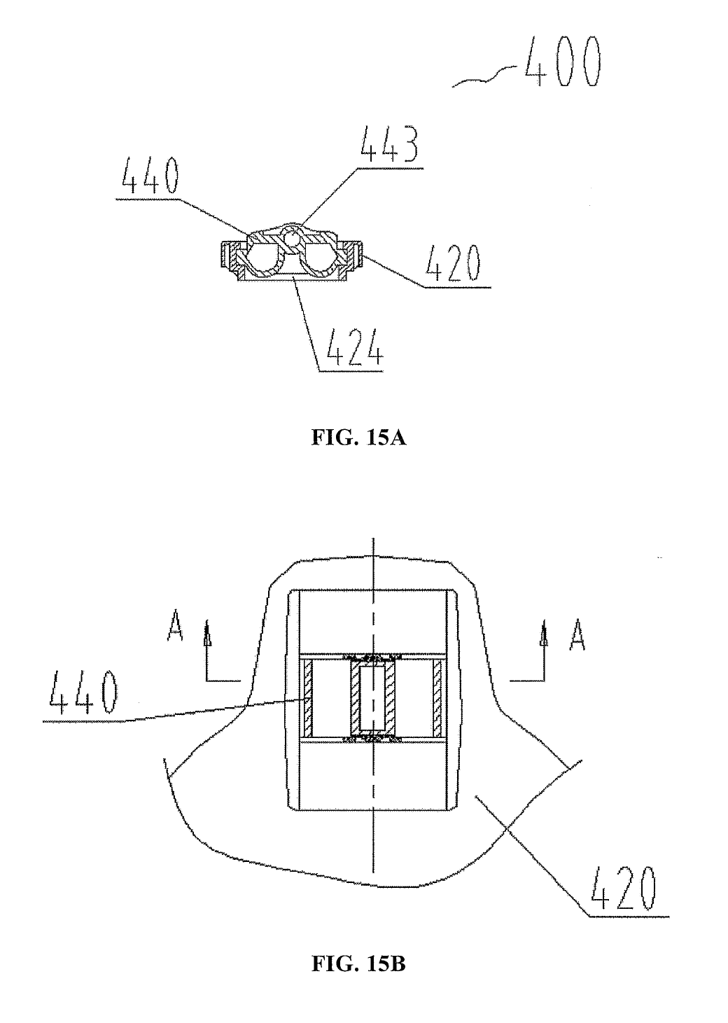

FIGS. 14A and 14B and FIGS. 15A and 15B are sectional and plan schematic diagrams showing a block-way structure of the cutter according to the fourth embodiment respectively.

As shown in FIGS. 14A and 14B and FIGS. 15A and 15B, in the slip fit of a sliding block 440 and a slide way 430 of the cutter 400, the slide way 430 includes a groove 424 which is provided in an operating rotary table 420 parallelly to an extension line of a kerf 421, laterally recessed slide grooves 431 are provided in side walls on both sides of the groove 424, a lower portion of the sliding block 440 has a shape matching the slide grooves 431 and is in slip fit with them, and an upper portion of the sliding block 440 is in hinged connection with the rocking bar through a hinge shaft hole 443.

Preferably, portions in which the two slide grooves 431 come in fit with the sliding block 440 have symmetric C-shaped sections (shown in FIGS. 14A and 14B) or [-shaped sections (FIGS. 15A and 15B).

Because the slide way 430 of the cutter 400 according to the fourth embodiment includes the pair of slide grooves 431 which are embedded in the groove 424 of the operating rotary table 420 or is formed integrally with the operating rotary table, and a hinge shaft hole 443 through which the sliding block 440 is in hinged connection with the rocking bar is located on or near the upper surface of the operating rotary table 420, beneficial effects substantially the same as those of the cutter 100 according to the first embodiment can be obtained.

### Fifth Embodiment

In addition to the sliding block and the slide way, a cutter 500 according to a fifth embodiment of the present invention has the same structure as that of the cutter 100 according to the first embodiment of the present invention. Components having the same function are assigned the identical reference numerals except that four hundreds are added thereto. Only differences between them will be described below to avoid redundancy.

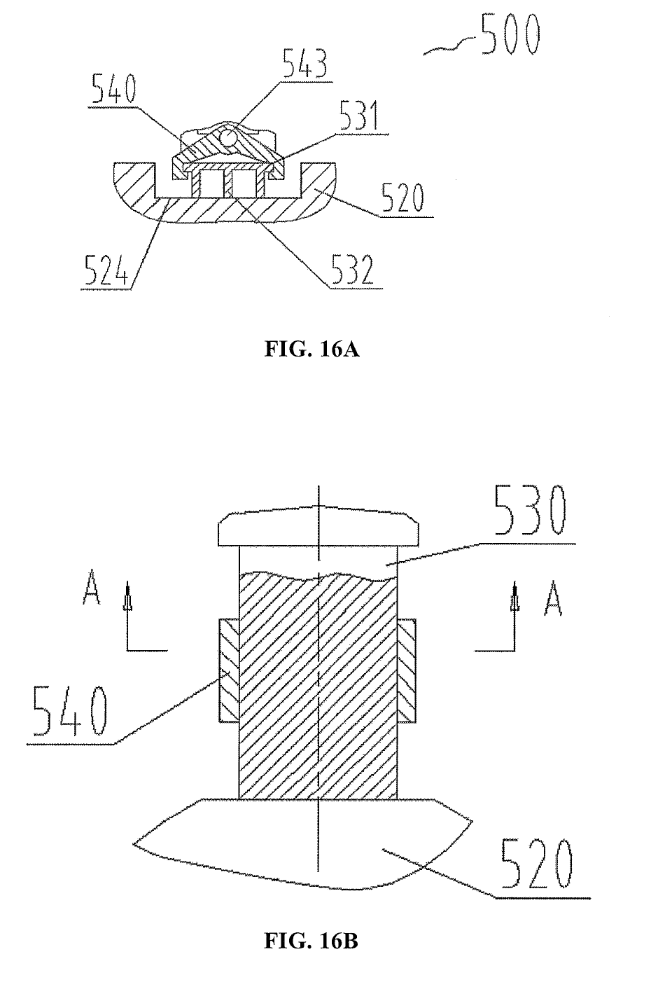

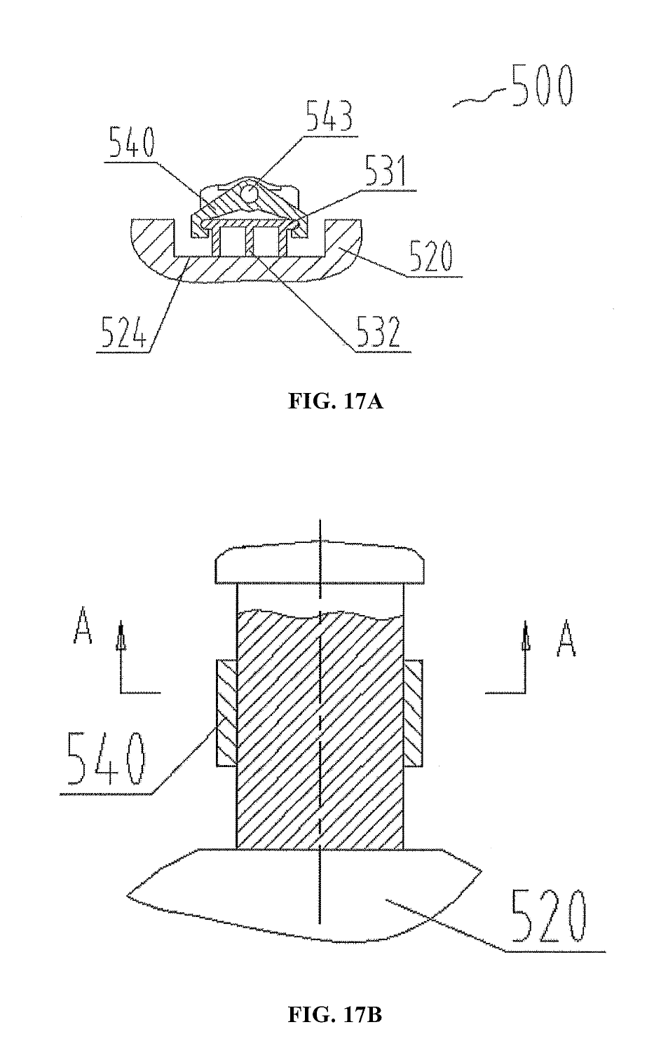

FIGS. 16A and 16B and FIGS. 17A and 17B are sectional and plan schematic diagrams showing a block-way structure of the cutter according to the fifth embodiment respectively.

As shown in FIGS. 16A and 16B and FIGS. 17A and 17B, in the slip fit of a sliding block 540 and a slide way 530, the slide way 530 includes a groove 524 with a U-shaped section which is provided in an operating rotary table 520 parallelly to an extension line of a kerf 521, a frame 532 with a Π-shaped section protrudes upward from a bottom of the groove 524, a pair of slide plates 531 with semicircular (shown in FIGS. 17A and 17B) sections or rectangular (shown in FIGS. 16A and 16B) sections are symmetrically provided on both sides of an upper end of the frame 532, and the sliding block 540 has a corresponding portion with a shape matching the slide plates 531 and is in slip fit with them.

Because the slide way 530 of the cutter 500 according to the fifth embodiment includes the pair of slide plates 531 which are fixedly connected to the bottom of the groove 524 in the operating rotary table 520, and a hinge shaft hole 543 through which the sliding block 540 is in hinged connection with the rocking bar is located on or near the upper surface of the operating rotary table 520, beneficial effects substantially the same as those of the cutter 100 according to the first embodiment can be obtained.

### Sixth Embodiment

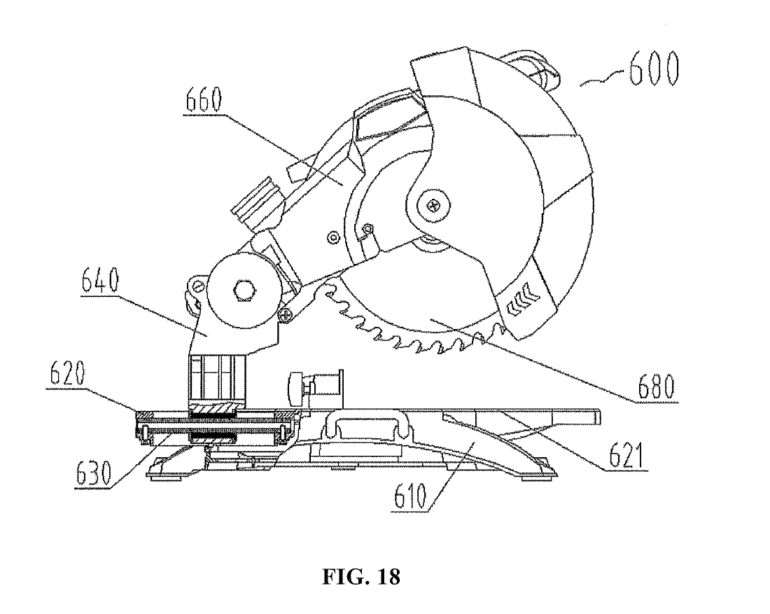

FIG. 18 is a schematic diagram showing a cutter according to a sixth embodiment of the present invention.

As shown in FIG. 18, a cutter 600 according to the sixth embodiment of the present invention comprises: a base 610; an operating rotary table 620 which is rotatably supported on the base 610, on a proximal end of which is provided with a linear kerf 621 provided in a proximal-distal direction, and on a distal end of which is provided with a slide way 630 provided along or parallelly to an extension line of the kerf 621; a sliding block 640, a lower portion of which is in slip fit with the slide way 630; a body 660, a distal end of which is in hinged connection with the sliding block 640 and on a proximal end of which is provided with a handle so that the body 660 is pivoted about a hinge shaft and is moved along the slide way 630 by virtue of force applied via the handle; a motor 670 having a casing which is fixedly connected to the body 660 so that a main shaft or a driven shaft driven by the main shaft of the motor is parallel to an upper surface of the operating rotary table 620; and a disk saw blade 680 which is nested on the main shaft or the driven shaft of the motor with its center hole and is fixed with it so that the disk saw blade is rotated along with rotation of the main shaft or the driven shaft, and a plane in which the disk saw blade 780 is aligned with the kerf 621 in the operating rotary table, wherein a maximum sliding distance of the sliding block 640 with respect to the slide way 630 corresponds to a length of the kerf 621, and the slide way 630 are fixedly connected to the operating rotary table 620 at least at its two ends.

By comparison with the cutter 100 according to the first embodiment of the present invention, the cutter 600 according to the sixth embodiment of the present invention is not provided with the rocking bar, thus the body 660 can not be pivoted leftward or rightward with respect to the operating rotary table 620 and the disk saw blade 680 can only perform cutting perpendicularly to the operating rotary table 620. In addition to this, the cutter 600 has the same function as that of the cutter 100. Therefore, the cutter 600 can obtain the same beneficial effects as those of the cutter 100 except that it can not be pivoted leftward or rightward with respect to the operating rotary table 620.

Modifications of Arrangement of the Slide Way and the Sliding Block

The arrangement of the slide way and the sliding block of the cutter in each of the embodiments of the invention can be modified variously according to requirements of design, and three modifications among them are given below.

Modification 1

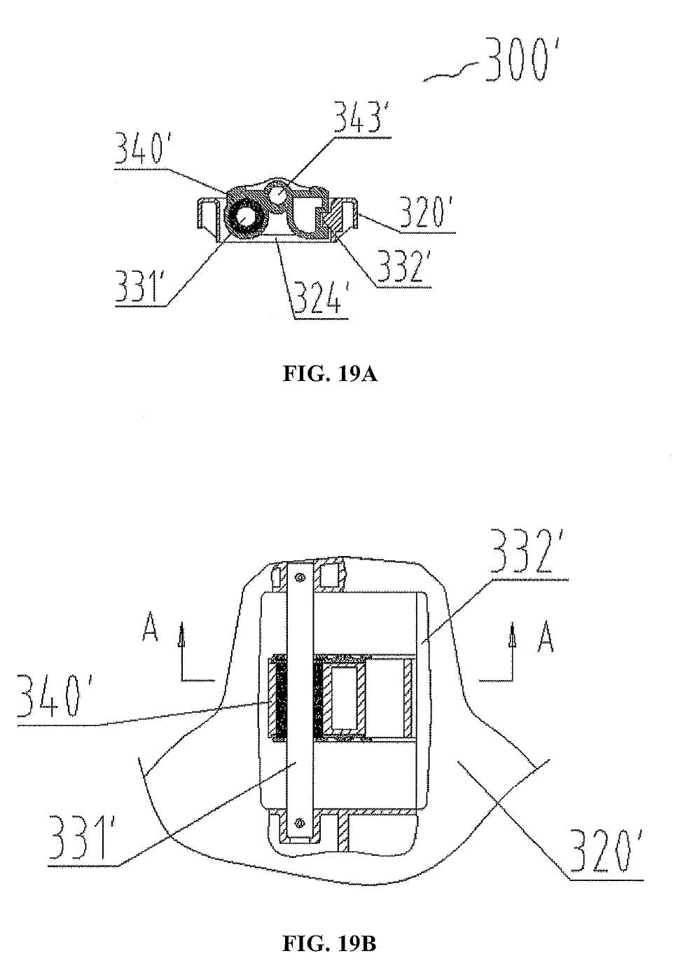

FIGS. 19A and 19B are schematic diagrams of Modification 1 regarding the slide way and the sliding block.

As shown in FIGS. 19A and 19B, the arrangement of Modification 1 is an alternative of that shown in FIGS. 13A and 13B.

In the slip fit of a sliding block 340′ and a slide way 330′ of a cutter 300′, the slide way 330′ includes a groove 324′ which is provided in an operating rotary table 320′ parallelly to an extension line of a kerf 321′, one cylindrical sliding rod 331′ is provided along the extension line on the left side of the groove 324′, and a laterally projected slide plate 332′ is provided in a side wall on the right side of the groove 324′. Positions where the sliding rod 331′ and the slide plate 332′ are provided are not limited thereto, and it is also possible that the one cylindrical sliding rod 331′ is provided along the extension line on the right side of the groove 324′, and the laterally projected slide plate 332′ is provided in a side wall on the left side of the groove 324′. A lower portion of the sliding block 340′ has a shape matching the sliding rods 331′ and the slide plate 332′ and is in slip fit with them, and an upper portion of the sliding block 340′ is in hinged connection with the rocking bar (not shown). Although it is only shown in FIG. 19A that the slide plate 332′ has a [-shaped section, the slide plate 332′ can have a C-shaped section or a section with any other proper shape known to those skilled in the art.

In arrangements of the slide way and the sliding block of the first to the sixth embodiments and Modification 1 of the present invention, the slide way includes two sliding rods or two slide plates or two slide grooves or a combination thereof. However, the slide way of the invention is not limited thereto. The slide way may include one or three or more sliding rods or one or three or more slide plates or one or three or more slide grooves or any combination thereof.

Modification 2

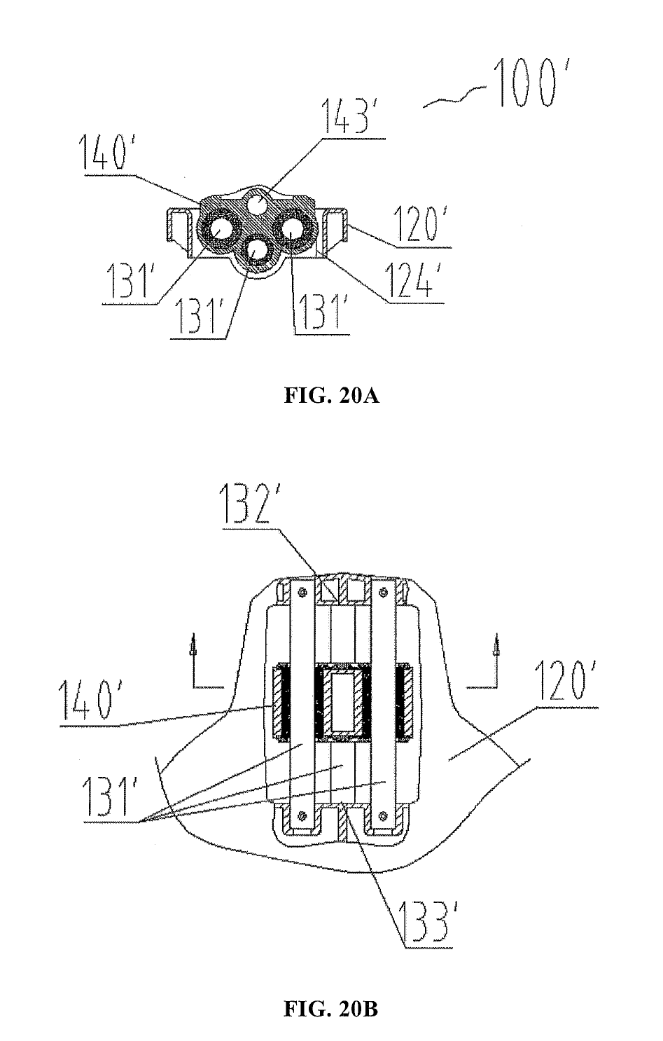

FIGS. 20A and 20B are schematic diagrams of Modification 2 regarding the slide way and the sliding block.

As shown in FIGS. 20A and 20B, the arrangement of Modification 2 is an alternative of that shown in FIGS. 11A and 11B. In the slip fit of a sliding block 140′ and a slide way 130′ of a cutter 100′, the slide way 130′ includes a groove 124′ which is provided in an operating rotary table 120′ parallelly to an extension line of a kerf 121′, and three cylindrical sliding rods 131′ are provided along the extension line in the groove 124′. A lower portion of the sliding block 140′ has a shape matching the cylindrical sliding rods 131′ and is in slip fit with them, and an upper portion of the sliding block 140′ is in hinged connection with the rocking bar (not shown).

Modification 3

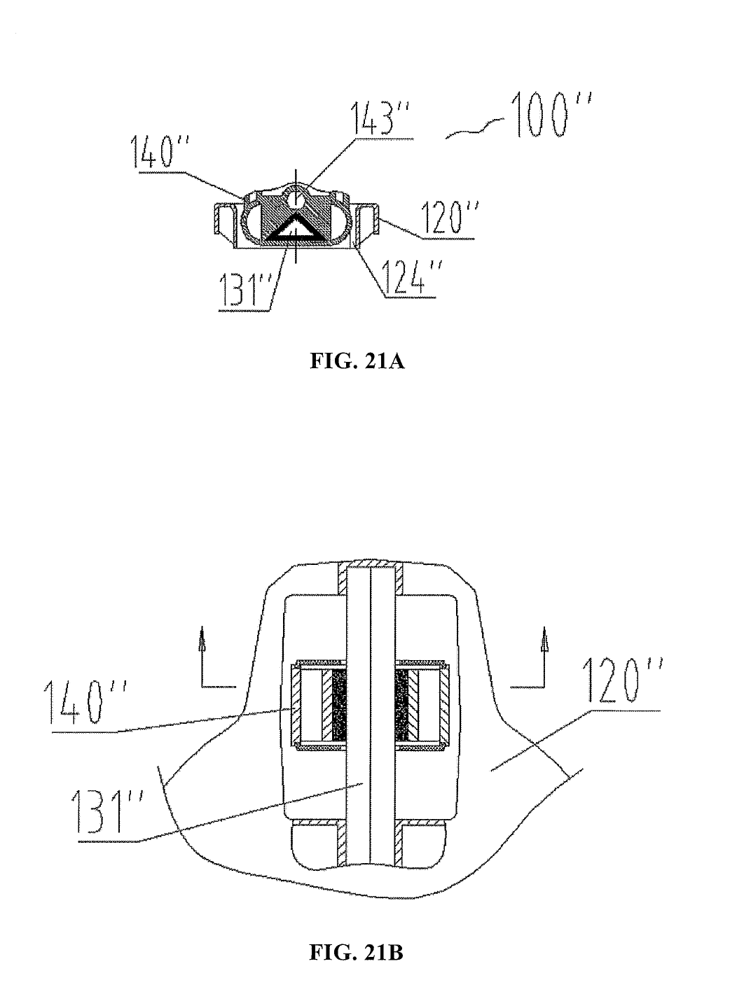

FIGS. 21A and 21B, FIGS. 22A and 22B, and FIGS. 23A and 23B are schematic diagrams of Modification 3 regarding the slide way and the sliding block.

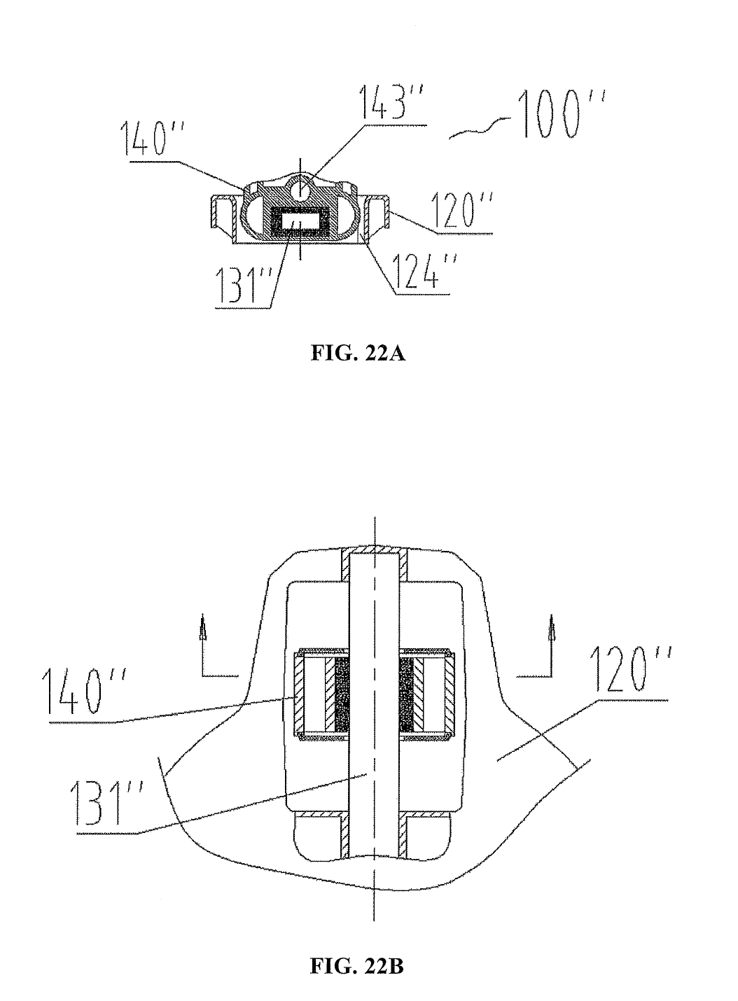

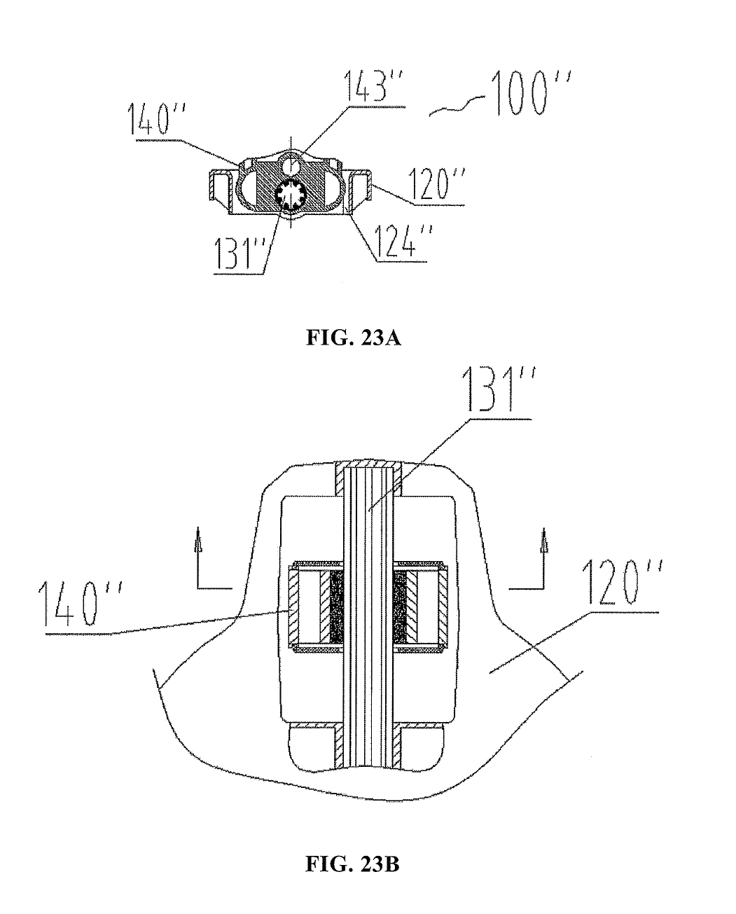

As shown in FIGS. 21A and 21B, FIGS. 22A and 22B, and FIGS. 23A and 23B, the arrangement of Modification 3 is an alternative of that shown in FIGS. 11A and 11B. In the slip fit of a sliding block 140″ and a slide way 130″ of a cutter 100″, the slide way 130″ includes a groove 124″ which is provided in an operating rotary table 120″ parallelly to an extension line of a kerf 121″, and one cylindrical sliding rod 131″ is provided along the extension line within the groove 124″. A lower portion of the sliding block 140″ has a shape matching the one cylindrical sliding rod 131″ and is in slip fit with it, and an upper portion of the sliding block 140″ is in hinged connection with the rocking bar (not shown). The one cylindrical sliding rod 131″ has a triangular section (shown in FIGS. 21A and 21B) or a rectangular section (shown in FIGS. 22A and 22B) or a splined section (shown in FIGS. 23A and 23B). Certainly, the shape of the slide way consisting of the single sliding rod is not limited thereto, and for example a section with an elliptic shape or a section with any other proper shape known to those skilled in the art may be used.

It is to be understood by those skilled in the art that various modifications, combinations, partial combinations or substitutions can be made to the present invention according to requirements of design and other factors, and all of these modifications, combinations, partial combinations and substitutions should fall within the scope of the present invention.

What is claimed is:

1. A cutter comprising:
a base;
an operating rotary table which is rotatably supported on the base, on a proximal end of which is provided with a linear kerf provided in a proximal-distal direction, and on a distal end of which is provided with a slide way provided along or parallelly to an extension line of the kerf;
a sliding block, one of an upper portion and a lower portion of which is in slip fit with the slide way;
a rocking bar, a lower end of which is in hinged connection with the other of the upper portion and the lower portion of the sliding block and can be locked so that the rocking bar is adjusted in its angle and is locked with respect to the sliding block in the left-right direction;
a body, a distal end of which is in hinged connection with the rocking bar and on a proximal end of which is provided with a handle so that the body is pivoted about a hinge shaft in the up-down direction and is moved along the slide way by a force applied via the handle;
a motor having a casing which is fixedly connected to the body so that a main shaft or a driven shaft driven by the main shaft of the motor is parallel to an upper surface of the operating rotary table; and
a disk saw blade which is mounted and fixed on the main shaft or the driven shaft of the motor with its center hole so that the disk saw blade is rotated along with rotation of the main shaft or the driven shaft, and a plane in which the disk saw blade is aligned with the kerf in the operating rotary table,
wherein a maximum sliding distance of the sliding block with respect to the slide way corresponds to a length of the kerf, and
wherein the slide way are fixedly connected to the operating rotary table at least at its two ends.

2. The cutter according to claim 1, wherein
in the slip fit of the sliding block and the slide way, the slide way includes a groove which is provided in the operating rotary table parallel to the extension line of the kerf, two cylindrical sliding rods are provided along the extension line within the groove, the lower portion of the sliding block has a shape matching the cylindrical sliding rods and is in slip fit with them, and the upper portion of the sliding block is in hinged connection with the rocking bar.

3. The cutter according to claim 1, wherein
in the slip fit of the sliding block and the slide way, the slide way includes a groove which is provided in the operating rotary table parallel to the extension line of the kerf, two cylindrical sliding rods are provided along the extension line above an upper surface of the operating rotary table on both sides of the groove, the upper portion of the sliding block has a shape matching the cylindrical sliding rods and is in slip fit with them, and the lower portion of the sliding block is contained within the groove and is in hinged connection with the rocking bar.

4. The cutter according to claim 1, wherein
in the slip fit of the sliding block and the slide way, the slide way includes a groove which is provided in the operating rotary table parallel to the extension line of the kerf, one cylindrical sliding rod is provided along the extension line on one side of the groove, a laterally recessed slide groove is provided in a side wall on the other side of the groove, the lower portion of the sliding block has a shape matching the sliding rod and the slide groove and is in slip fit with them, and the upper portion of the sliding block is in hinged connection with the rocking bar.

5. The cutter according to claim 4, wherein
the slide groove has a C-shaped section or a [-shaped section.

6. The cutter according to claim 1, wherein
in the slip fit of the sliding block and the slide way, the slide way includes a groove which is provided in the operating rotary table parallel to the extension line of the kerf, laterally recessed slide grooves are provided in side walls on both sides of the groove, the lower portion of the sliding block has a shape matching the slide grooves and is in slip fit with them, and the upper portion of the sliding block is in hinged connection with the rocking bar.

7. The cutter according to claim 6, wherein
the slide grooves have C-shaped sections or [-shaped sections.

8. The cutter according to claim 1, wherein
in the slip fit of the sliding block and the slide way, the slide way includes a groove which is provided in the operating rotary table parallel to the extension line of the kerf, a frame with a H-shaped section protrudes upward from a bottom of the groove, slide plates with semicircular or rectangular sections are symmetrically provided on both sides of an upper end of the frame, and the sliding block has a corresponding portion with a shape matching the slide plates and is in slip fit with them.

9. The cutter according to claim 1, wherein
in the slip fit of the sliding block and the slide way, the slide way includes a groove which is provided in the operating rotary table parallel to the extension line of the kerf, three cylindrical sliding rods are provided along the extension line above an upper surface of the operating rotary table on both sides of the groove, the lower portion of the sliding block has a shape matching the cylindrical sliding rods and is in slip fit with them, and the upper portion of the sliding block is in hinged connection with the rocking bar.

10. The cutter according to claim 1, wherein
in the slip fit of the sliding block and the slide way, the slide way includes a groove which is provided in the operating rotary table parallel to the extension line of the kerf, one cylindrical sliding rod is provided along the extension line on one side of the groove, a laterally projected slide plate is provided in a side wall on the other side of the groove, the lower portion of the sliding block has a shape matching the sliding rods and the slide plate and is in slip fit with them, and the upper portion of the sliding block is in hinged connection with the rocking bar.

11. The cutter according to claim 1, wherein
in the slip fit of the sliding block and the slide way, the slide way includes a groove which is provided in the operating rotary table parallel to the extension line of the kerf, one cylindrical sliding rod is provided along the extension line within the groove, the lower portion of the sliding block has a shape matching the one cylindrical sliding rod and is in slip fit with it, and the upper portion of the sliding block is in hinged connection with the rocking bar.

12. The cutter according to claim 11, wherein
the one cylindrical sliding rod has a triangular or rectangular or splined section.

13. The cutter according to claim 1, wherein
a center of a hinge shaft through which the sliding block and the rocking bar are connected is located on or above or below the upper surface of the operating rotary table at a distance equal to or smaller than 5 mm from the upper surface.

14. The cutter according to claim 13, wherein
the center of the hinge shaft is located on the upper surface of the operating rotary table.

15. The cutter according to claim 1, wherein
the following relational expression is satisfied: A<C+E, wherein A denotes a maximum width of a workpiece to be processed, C denotes a maximum sliding distance of the sliding block with respect to the slide way, and E denotes a cutting distance of the disk saw blade itself.

16. A cutter comprising:
a base;
an operating rotary table which is rotatably supported on the base, on a proximal end of which is provided with a linear kerf provided in a proximal-distal direction, and on a distal end of which is provided with a slide way provided along or parallelly to an extension line of the kerf;
a sliding block, a lower portion of which is in slip fit with the slide way;
a body, a distal end of which is in hinged connection with the rocking bar and on a proximal end of which is provided with a handle so that the body is pivoted on the hinge in the up-down direction and is moved along the slide way by a force applied via the handle;
a motor having a casing which is fixedly connected to the body so that a main shaft or a driven shaft driven by the main shaft of the motor is parallel to an upper surface of the operating rotary table; and
a disk saw blade which is mounted and fixed on the main shaft or the driven shaft of the motor with its center hole and is fixed with it so that the disk saw blade is rotated along with rotation of the main shaft or the driven shaft, and a plane in which the disk saw blade is aligned with the kerf in the operating rotary table,
wherein a maximum sliding distance of the sliding block with respect to the slide way corresponds to a length of the kerf, and
wherein the slide way are fixedly connected to the operating rotary table at least at its two ends.
